(19) United States
(12) Patent Application Publication
(10) Pub. No.: US 2015/0324614 A1
(43) Pub. Date: Nov. 12, 2015

(54) Image Analysis

(71) Applicants: Prasenjit Dey, (US); Serene Banerjee, (US); Sriganesh Madhvanath, (US); Hewlett-Packard Development Company, L.P., Houston, TX (US)

(72) Inventors: Prasenjit Dey, Karnataka (IN); Serene Banerjee, Bangalore (IN); Sriganesh Madhvanath, Bangalore (IN)

(21) Appl. No.: 14/647,138

(22) PCT Filed: Nov. 29, 2012
(86) PCT No.: PCT/IB2012/003113

§ 371 Date: May 26, 2015

(51) Int. Cl. G06F 21/84; G06T 11/60; G06K 9/62

(52) U.S. Cl. CPC G06F 21/84; G06K 9/6217; G06T 11/60

(57) ABSTRACT

Provided is a method for performing analysis on an image. An image is provided to users, wherein contents of the image are hidden from the users. Information regarding the contents of the image is collected from the users wherein a question is posed to the users to determine contents of the image. Alternate inputs are received from the users to reveal the contents of the image, wherein each input from the users partially reveals the contents of the image. A response to the question from the users is received until it is determined that an input from one of the users would reveal an identity of a human subject present in the image.

### BACKGROUND

A large amount of data generated these days whether by individuals or organizations is unstructured in character. Some common examples of unstructured data include images, videos, emails, company reports, training manuals, and web pages, etc. Unstructured data, which could contain a wealth of valuable information for an enterprise, is difficult to analyze owing to the nature of its format. Analyzing image and video data is even more challenging.

### BRIEF DESCRIPTION OF THE DRAWINGS

For a better understanding of the solution, embodiments will now be described, purely by way of example, with reference to the accompanying drawings, in which:

FIG. 1 is a schematic diagram of a representative computer system infrastructure for performing image analysis, according to an example.

FIG. 2 shows a block diagram of an image analysis module hosted at a computer system, according to an example.

FIG. 3 illustrates a flow chart of a method for performing analysis on an image, according to an example.

FIG. 4 shows a schematic illustration of an image with a tile overlay, according to an example.

FIG. 5 shows a schematic illustration of an image with a tile overlay partially revealing its contents, according to an example.

### DETAILED DESCRIPTION OF THE INVENTION

Image analysis is a process of extracting meaningful information from images. For the sake of clarity, the term “image” is hereby defined to include both still images (such as a photograph, a map, etc.) and moving images (such as a video, a film, etc.). The term also includes both two-dimensional and three-dimensional images. In an example, a still image extracted from a moving image, for instance a video image (or video frame) extracted from a video is also considered a part of the definition.

As mentioned earlier, it is challenging to perform image analysis to obtain relevant information. One mechanism is to use crowdsourcing. In crowdsourcing, a task is outsourced to an unknown group of people (typically called “crowdsourced agents”) who are asked to submit solutions. The solutions are typically owned by the individual or enterprise that outsourced the task. Crowdsourcing could be used to perform image analysis. However, sharing images or videos with crowdsourced agents to extract information has a problem—privacy. Important data, especially identity, of the subjects in the images (or videos) could be revealed to the people performing crowdsourcing, which may result in drastic legal and monetary consequences to the enterprise trying to process the image data.

Proposed is a solution that helps in performing image analysis without compromising on the privacy of human subjects who may be present in the image. In an example, a proposed solution is designed as a human-based computation game or game with a purpose (GWAP) that allows image analysis to be performed using crowdsourced agents without disclosing the identity of the subjects (human and/or non-human) in the image.

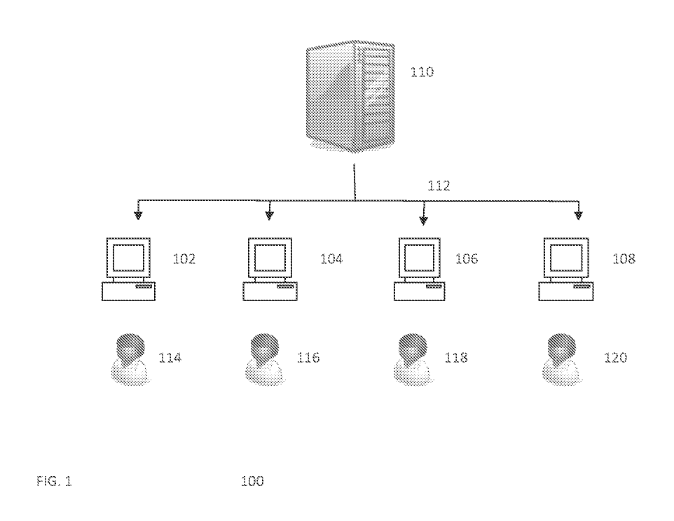

FIG. 1 is a schematic diagram of a representative computer system infrastructure for performing image analysis, according to an example. Computer system infrastructure 100 comprises of a plurality of computer systems 102, 104, 106 and 108, and server computer 110. It should be noted that the number of infrastructure components (computer systems 102, 104, 106 and 108, and server computer 110) shown in FIG. 1 is merely illustrative and additional numbers of aforementioned components may be present in other examples.

Various components of computer system infrastructure 100 i.e. computer systems 102, 104, 106 and 108, and server computer 110 could be connected to each other through network 112, such as an Ethernet, local area network (LAN), a wide area network (WAN), the internet, or the like. Network 112 may be physical (for example, co-axial cable) or wireless (for example, Wi-Fi).

Computer systems 102, 104, 106 and 108 may be a desktop computer, notebook computer, tablet computer, mobile phone, personal digital assistant (PDA), smart phone, server computer, or the like.

Server computers 110 is a computer or computer application (machine executable instructions) that provide services to other computers or computer applications. Depending on the computing service that it offers server computer 110 could be gaming servers, database servers, print servers, web servers, file servers, mail servers, or some other kind of servers. In an example, server computer 110 may include a storage device such as, but not limited to, tape drives, disk drives, disk array, optical discs (such as, CD, DVD and Blu-ray disc), redundant array of independent disks (RAID), etc. for storing a computer application(s) (machine executable instructions). In another example, computer systems 102, 104, 106 and 108 may also include a storage device, such as of the type hereinbefore mentioned, for storing a computer application (machine executable instructions).

In an example, computer systems 102, 104, 106 and 108 may be used by users 114, 116, 118, and 120 respectively. Users 114, 116, 118, and 120 may be co-located or located independent of each other, for instance, at different geographical locations. Also, users 114, 116, 118, and 120 may be known or unknown to each other. In an example, users 114, 116, 118, and 120 are randomly paired (virtually connected) over a computer network such as network 112. In another example, more than two users may be randomly connected over network 112. Also, in an implementation, a computer application (machine readable instructions) may be provided that allows a user to log into network 112 to connect with other users.

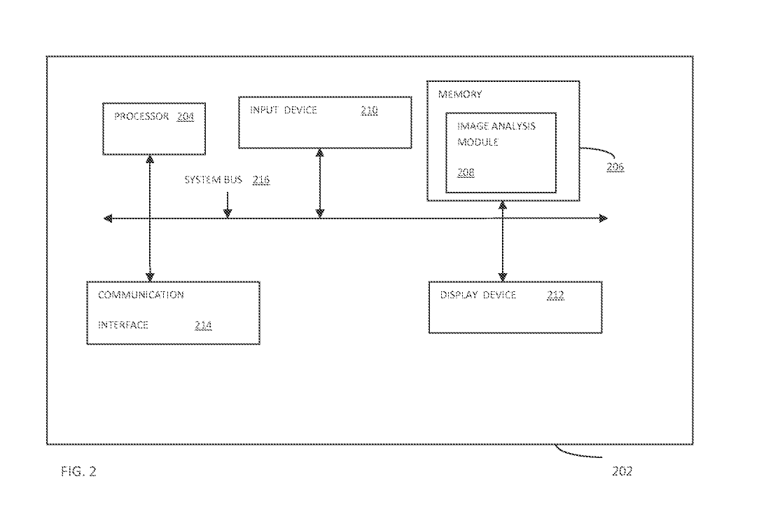

FIG. 2 shows a block diagram of an image analysis module hosted at a computer system 202, according to an example.

Computer system 202 may be a computer server, desktop computer, notebook computer, tablet computer, mobile phone, personal digital assistant (PDA), or the like. In an example, computer system 202 may be a computer system 102, 104, 106 or 108 of FIG. 1. In another example, computer system 202 may be computer server 110 of FIG. 1.

Computer system 202 may include processor 204, memory 206, image analysis module 208, input device 210, display device 212, and a communication interface 214. The components of the computing system 202 may be coupled together through a system bus 216.

Processor 204 may include any type of processor, microprocessor, or processing logic that interprets and executes instructions.

Memory 206 may include a random access memory (RAM) or another type of dynamic storage device that may store information and instructions non-transitorily for execution by processor 204. For example, memory 206 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. Memory 206 may include instructions that when executed by processor 204 implement image analysis module 208.

Image analysis module 208, in an implementation, provides an image to users, wherein contents of the image are hidden from the users; collects information regarding the contents of the image from the users, wherein collecting the information regarding the contents of the image from the users comprises: posing a question to the users to determine contents of the image; receiving alternate inputs from the users to reveal the contents of the image, wherein each input from the users partially reveals the contents of the image; and receiving a response to the question from the users until it is determined that an input from one of the users would reveal an identity of a human subject present in the image.

Image analysis module 208 may be implemented in the form of a computer program product including computer-executable instructions, such as program code, which may be run on any suitable computing environment in conjunction with a suitable operating system, such as Microsoft Windows, Linux or UNIX operating system. In an implementation image analysis module may be installed on computer server 110 and/or any of the computer systems 102, 104, 106 and 108 accessed by a user(s). Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

In an implementation, image analysis module 208 may be read into memory 206 from another computer-readable medium, such as data storage device, or from another device via communication interface 216.

Input device 210 may include a keyboard, a mouse, a touch-screen, or other input device. Display device 212 may include a liquid crystal display (LCD), a light-emitting diode (LED) display, a plasma display panel, a television, a computer monitor, and the like.

Communication interface 214 may include any transceiver-like mechanism that enables computing device 202 to communicate with other devices and/or systems via a communication link. Communication interface 214 may be a software program, a hard ware, a firmware, or any combination thereof. Communication interface 214 may provide communication through the use of either or both physical and wireless communication links. To provide a few non-limiting examples, communication interface 214 may be an Ethernet card, a modem, an integrated services digital network (“ISDN”) card, etc.

It would be appreciated that the system components depicted in FIG. 2 are for the purpose of illustration only and the actual components may vary depending on the computing system and architecture deployed for implementation of the present solution. The various components described above may be hosted on a single computing system or multiple computer systems, including servers, connected together through suitable means.

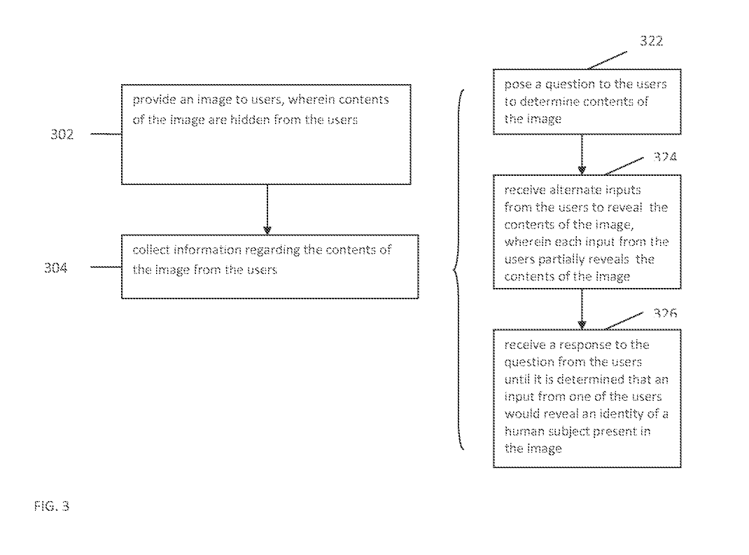

FIG. 3 illustrates a flow chart of a method for performing analysis on an image, according to an example. At block 302, an image is provided to users who are connected over a computer network. A user may connect to the computer network through a computer system such as, but not limited to, the one described earlier in relation to FIG. 2. In an example, a user may be required to log into the computer network through a computer application (such as a chat application) in order to receive an image. All users who login in such a manner are identified. In an example, once such users have been identified, a user is randomly paired with another user for receiving an image. In another instance, a plurality of users may be selected as a group to receive an image.

In an example, an identical image is provided to the users who have been randomly paired or grouped. In other words, similar copies of the image are shared with the paired or grouped users. The shared image may be displayed on a display device coupled to the selected user's computer system.

In an example, the image is provided by a server computer which may be coupled to the computer network through a wired or wireless means. The server computer hosts the image in question and, optionally, other images as well. The image could be a still image such as a photograph, a map, printed or handwritten documents, etc. or a still image extracted from a moving image, for instance a video image (or video frame) extracted from a video. Examples may include video images extracted from a surveillance video of a retail store, bank, shopping mall, hospital, train station, etc.

A shared image may include a variety of subject matters including human subjects. In an implementation, an image may include an object that could identify an individual (i.e. a person who may or may not be a subject of the image). Some non-limiting examples of such objects may include social security number, passport number, personnel identification number and driving license details of individuals. Also, some non-limiting examples of images that may include such objects could include patient records, employment records, etc.

The contents of an image shared with the users are hidden from the users. In an implementation, the image provided to the users is covered in a manner that contents of the image are invisible to the users. For example, the image may be covered with an overlay of tiles. In another example, the image may be blurred to conceal the contents. In any case, the contents of a shared image are made visible in response to inputs received from a user(s). For instance, a cover on the image (say, an overlay of tiles) is removable in response to inputs received from a user(s) to show the contents of an image. In an example, each input from a user only partially reveals the contents of an image. For instance, in case an image is covered with an overlay of tiles, each input from a user may remove a tile (or a set of tiles). In another instance, if an image is blurred, each user input may progressively deblur the image. Some non-limiting examples of user inputs may include inputs from an input device (such as a mouse or keyboard), touch inputs, voice inputs, etc.

At block 304, information regarding the contents of the image (shared earlier) is collected from the users with whom the image was shared at block 302. In an example, information regarding the contents of the image is obtained by posing a question(s) to the users to determine the contents of the image (block 322). Block 322 along with blocks 324 and 326 (described below) describe a subroutine of block 304. Questions may be posed sequentially (one at a time) or a set of questions may be asked together. In an example, question(s) are displayed, along with the image shared earlier, on a display device coupled to the selected user's computer systems.

The purpose of asking questions is to obtain information regarding the contents of an image that has been shared with the users. In other words, the aim is to conduct an image analysis in order to extract meaningful information from the image. Some non-limiting example of questions that may be posed to the users include: (a) how many people are present in the image?, (b) how many males are present in the image?, (c) how many children are present in the image, (d) how many logos are visible in the image, (e) what brand names are present in the image? etc. There's no limitation as to the number and variety of questions that may be posed to the users.

At block 324, alternate inputs are received from the users to reveal the contents of the image. Alternate inputs ensure that the information that is entered can be accurately accounted for. Since the image provided to users is covered in a manner that contents of the image are hidden from the users, alternate inputs are received from the users to sequentially reveal the contents of the image. For example, if an image provided to a pair of users at block 302 is covered with an overlay of tiles, alternate inputs would be received from both the users to reveal the contents of the image. As mentioned earlier, a cover on the image is removable in response to inputs received from a user(s) to show the contents of an image. In an example, each input from a user only partially reveals the contents of an image. In case of a pair of users, each input from a user would partially remove the cover (a tile or set of tiles, in this case) to reveal the contents. A user input may be obtained from an input device (such as a mouse or keyboard), touch, voice, gestures, or in any combination thereof.

An input provided by a user is visible to all other users who were provided with the image in the first instance. For example, in case an image (with an overlay of tiles) has been shared with a pair of users, an input by a user to remove a tile from the overlay (by clicking on the tile, for instance) would be visible to the other user.

At block 326, a response to the question(s) posed earlier is received from the users until it is determined that an input from one of the users would reveal an identity of a human subject present in the image. Since each input from a user(s) begins to reveal the contents of the shared image, the user(s) are able to obtain access to data in the image which helps them provide an answer to the question(s). Also, since alternate inputs are received from the users to reveal the contents of the image, each user gets an equal and alternate opportunity to provide a response to the question as well. The response provided by a user may be stored, for instance, in a database on the server computer that provided the image. In an example, once a question is answered by both (in case of a pair) or all (in case of a group) the users, the question is locked and no further response from a user is accepted. Since the answers get locked, the users are required to have all the information before they put in an answer. For example, for questions related to people counting, it is desirable to first reveal all the information in the image (not the face of subjects) and then enter the number in the answer.

A user may keep on providing a response to the question(s) until it is determined that an input from one of the users would reveal an identity of a human subject present in the image. Since it is imperative to maintain the privacy of human subjects in an image, once it is determined that the identity of a human subject might be revealed, no further user inputs are entertained and, in one instance, the image is blocked from view of the users. In other words, each user should provide an input in such as way that they do not reveal the face or identity of a subject while getting as much information about the image as possible. For example, in case of an image (with an overlay of tiles) provided to a pair of users, each user should provide an input (for instance, by clicking on tiles) in such a manner that neither of them reveals the identity of a human subject.

In an example, a determination that an input from one of the users would reveal an identity of a human subject in the image is made when an alarm is raised by one of the users. A user may raise an alarm when he or she realises than an input from another user may reveal the identity of a subject. For instance, in case an image (with an overlay of tiles) has been shared with a pair of users, an input by a user to remove a tile from the overlay (by clicking on the tile, for instance) presumably associated with an identity of a subject may cause another co-user to raise an alarm.

An alarm from a user may be received in many ways. For example, when a user presses a pre-defined key on a keyboard (say, f12), clicks or taps at a particular pre-defined location of a user interface on the display screen, provides a pre-defined audio input to his computer system, etc.

Aforesaid alarm raised by a user is recognised and no further user inputs related to the image (for example, a response to a question) are accepted. Further action, such as but not limited to, may include blocking the image from the view of the users.

In an implementation, the aforegiven method may be implemented in the form of a game with a purpose (GWAP) between two or more unknown outsourced agents whose incentives are designed to perform as much analytics as possible on an image without compromising the identity of the subjects in the image. The game may stop when an agent raises an alarm or all questions are answered.

In another implementation, the image provided to the selected users could be of a document (for instance, printed or handwritten) whose contents may need to be digitized. Since Optical Character Recognition (OCR) systems do not work well on hand written or old printed documents, they may require human intervention. The documents however may contain privacy sensitive information (bank account number, social security number, disease records etc.). In the present case, the document may be hidden by an appropriate mechanism (such as an overlay of tiles, etc.) and the users may be required to reveal and transcribe the document in digital form without revealing the privacy sensitive information. In other implementations, any content which may be difficult or time consuming to identify and interpret individually may be shared in the form of an image with a selected group of individuals. By broadly using the aforementioned method such content could be easily determined in a less amount of time.

In an example, an incentive mechanism is incorporated in the aforegiven method wherein users are given incentives for providing as much information as possible about an image without revealing the identity of human subjects present therein. For instance, users who were provided an image for analysis may be rewarded for answers where they agree with each other. The users have an incentive to say the truth since they are randomly paired and cannot collude. If they do not answer truthfully, they are most likely to disagree on the answer and both will not be paid any reward, which may be monetary and/or non-monetary. Moreover, there is no second chance. As soon as all selected users put in their answer for a particular question it is locked. So they have an incentive to answer truthfully in single attempt to get the reward. The answer entered by each user is not revealed to the others until it is locked and in agreement.

In another instance, a user may be rewarded an extra bonus if he or she raises an alarm in the game whenever the identity of a human subject is being revealed. Each user has an incentive to earn the maximum from each correct answer while having an additional reward motivation to raise an alarm if another user tries to reveal an identity (a face) of a subject. If a user tries to ignore the identity revealing behaviour of the other user, it is very likely that another user may raise the alarm and take the reward since an input is strictly obtained by turn. Once an alarm is raised, no further action related to the image is accepted (said differently, the game is stopped) and the users do not have a chance to provide a further response to questions (i.e. to play the currently running game again). To ensure the alarm is not misused by a user to earn a reward, a snapshot of tile for which alarm is raised is sent as verification task to another set of users to confirm that it was indeed a true alarm. The payment for the alarm bonus is not immediate. It is kept under a state of processing until verification is complete. This ensures that there are no quick reward earning users who fly out with immediate awards, and the users have a deterrence not to raise false alarms. The bonus is paid only on verification. In an example, when users are found to raise false alarms, their bonus payment is stopped and their reputation is lowered.

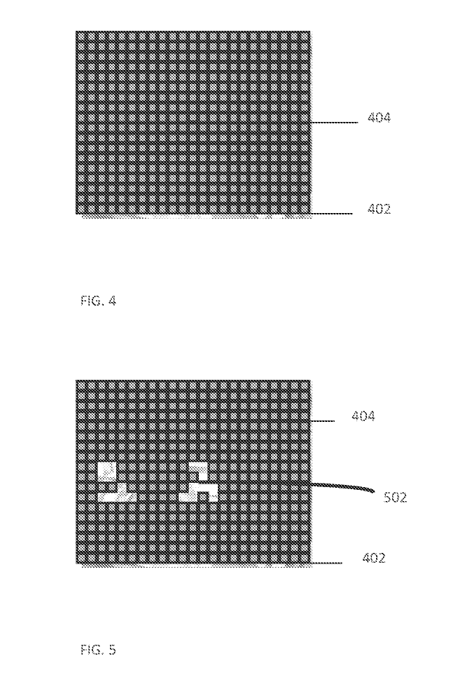

FIG. 4 shows a schematic illustration of an image 402 with a tile overlay 404, according to an example. An image provided to users for obtaining information about its contents may be covered in a manner that contents of the image are hidden from the users. In an example, the image may be covered with an overlay of tiles. FIG. 4 provides an illustration of this example. As mentioned earlier, a cover on the image is removable in response to inputs received from a user(s) to show the contents of an image. In an example, each input from a user only partially reveals the contents of an image. For instance, in case an image is covered with an overlay of tiles, each input from a user may remove a tile (or a set of tiles). FIG. 5 provides an illustration of this example wherein an image 402 with a tile overlay 404 has partially revealed its contents 502 after user inputs.

Proposed method provides an attractive mechanism for users to annotate images and video, where the users do the work for fun, without compromising the privacy of human subjects present therein.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A method for performing analysis on an image, comprising:
providing the image to users, wherein contents of the image are hidden from the users; and
collecting information regarding the contents of the image from the users, wherein collecting the information regarding the contents of the image from the users comprises:
posing a question to the users to determine contents of the image;
receiving alternate inputs from the users to reveal the contents of the image, wherein each input from the users partially reveals the contents of the image; and
receiving a response to the question from the users until it is determined that an input from one of the users would reveal an identity of a human subject present in the image.

2. The method of claim 1, wherein determining that an input from one of the users would reveal an identity of a human subject present in the image comprises:
receiving an alert from one of the users indicating that another user has provided an input to reveal the identity of the human subject present in the image.

3. The method of claim 2, further comprising providing a reward to a user who raised the alert.

4. The method of claim 3, wherein the reward is monetary and/or non-monetary.

5. The method of claim 1, further comprising providing a reward to the users if their responses to the question match.

6. The method of claim 1, wherein the users are randomly selected.

7. The method of claim 1, wherein the image is covered with an overlay of tiles.

8. The method of claim 1, wherein the image is blurred.

9. A computer system for performing analysis on an image, comprising:
a display device to display an image to a user, wherein contents of the image is hidden from the user; and
an image analysis module to collect information regarding the contents of the image from the user, wherein to collect the information regarding the contents of the image from the user comprises:
posing a question related to the contents of the image to the user;
receiving inputs from the user to reveal the contents of the image, wherein each input from the user alternates with inputs from another user and each input partially reveals the contents of the image; and
receiving a response to the question from the user until it is determined that an input from the user or the another user would reveal an identity of a human subject present in the image.

10. The system of claim 9, wherein the image is obtained from a video.

11. A system for performing analysis on an image, comprising:
a plurality of display devices to display an image to users of the plurality of display devices, wherein the image is covered with an overlay in a manner that contents of the image is hidden from the users; and
an image analysis module on a computer server to collect information regarding the contents of the image from the users, wherein to collect the information regarding the contents of the image from the users comprises:
posing a question related to the contents of the image to the users, wherein the question is displayed on the plurality of display devices;
receiving alternate inputs from the users to reveal the contents of the image, wherein each input partially reveals the contents of the image; and
receiving a response to the question from the users until it is determined that an input from a user would reveal an identity of a human subject present in the image.

12. The system of claim 11, wherein the overlay is a set of removable tiles.

13. The system of claim 11, wherein the inputs from the users is one of a device input, touch input, voice input and gesture input.

14. The system of claim 11, further comprising storing the response to the question in a database.

15. A non-transitory processor readable medium, the non-transitory processor readable medium comprising machine executable instructions, the machine executable instructions when executed by a processor causes the processor to:
provide an image to users, wherein contents of the image are hidden from the users; and
collect information regarding the contents of the image from the users, wherein collecting the information regarding the contents of the image from the users comprises:
pose a question to the users to determine contents of the image;
receive alternate inputs from the users to reveal the contents of the image, wherein each input from the users partially reveals the contents of the image; and
receive a response to the question from the users until it is determined that an input from one of the users would reveal an identity of a human subject present in the image.
